(19) United States
(12) Patent Application Publication
(10) Pub. No.: US 2010/0028660 A1
(43) Pub. Date: Feb. 4, 2010

(54) POLYMERIZABLE COMPOSITION AND ITS USES

(75) Inventors: Kun-Ming YEH, Kaohsiung (TW); Po-Wen LIN, Kaohsiung (TW); Shih-Yi CHUANG, Kaohsiung (TW); Yi-Chung SHIH, Kaohsiung (TW)

Correspondence Address: LADAS & PARRY LLP, 26 WEST 61ST STREET, NEW YORK, NY, 10023, US

(73) Assignee: CHEMICAL CO., LTD.

(21) Appl. No.: 12/512,591

(22) Filed: Jul. 30, 2009

(30) Foreign Application Priority Data
Aug. 1, 2008 (TW) 097129379

(51) Int. Cl. B32B 27/36; C08F 2/46

(52) U.S. Cl. 428/334; 522/181; 522/46; 522/40; 522/37; 522/43; 522/42; 522/64; 522/81; 522/83; 522/82

(57) ABSTRACT

The present invention provides a polymerizable composition, which comprises:
(a) at least one monomer of formula (I):

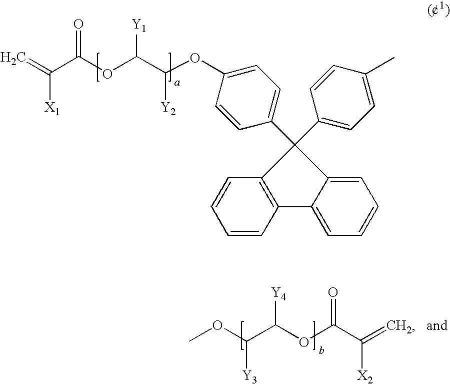

(b) a photo-initiator,
wherein X₁, X₂, Y₁, Y₂, Y₃, Y₄, a, and b are as defined in the specification and the amount of the monomer of formula (I) is at least 1 wt %, based on the total weight of the polymerizable composition.

The present invention also provides an optical film comprising a coating layer formed from the above polymerizable composition. The optical film can be used in backlight modules of displays as a brightness enhancement film.

### BACKGROUND OF THE INVENTION

1. Field of the Invention

The present invention relates to a polymerizable composition and an optical film comprising a coating layer formed from the above polymerizable composition. The optical film can be used in backlight modules of displays as a brightness enhancement film.

2. Description of the Prior Art

Liquid crystal displays (LCD) have replaced conventional cathode ray tube (CRT) displays due to numerous advantages, including low weight, thin profile, small size, low heat emission, reduced electricity consumption, lack of radiation damage, and so on.

Using various optical films in backlight modules is currently the most economical and convenient approach to enhancing panel luminance. This approach enhances LCD brightness and utilizes the light source effectively without requiring part redesign or excessive energy consumption.

A brightness enhancement film (BEF), also known as a light-gathering film, can be obtained by applying a special acrylic resin on a polyester substrate and curing the resin with a high energy UV light to form prism microstructures thereon. The main function of brightness enhancement film is to collect the disordered light emitted from a light guide by refraction and total internal reflection, and direct the light to an on-axis direction of about ±35 degrees, so as to enhance the luminance of the LCD.

Common brightness enhancement films gather light by linear prism columnar structures. The refracted light rays from a brightness enhancement film containing linear prism columnar structures are liable to optically interfere with refracted or reflected light rays from other films in the displays or with other light rays refracted or reflected from the brightness enhancement film itself, thereby resulting in the appearance of Moiré or Newton rings. U.S. Pat. No. 6,280,063 discloses a brightness enhancement film comprising arc columnar structures, which can integrate light-gathering and light-diffusion functions to achieve the purposes of gathering and homogenizing light and reducing light interference. Furthermore, a brightness enhancement film comprising arc columnar structures can reduce the impairment caused by contact between prism structures and other films or panels and enhance wear resistance. However, brightness enhancement film comprising arc columnar structures will reduce luminance. A common approach to compensate for loss of luminance is to use a polymer coating having a higher refractive index. In general, the higher the refractive index of the polymer coating, the better the brightness enhancement effect of the brightness enhancement film, as disclosed, for example, in JP 5-127159.

It is known that a polymer coating having a higher refractive index can be obtained by adding halogen. However, the use of halogen causes environmental pollution.

U.S. Pat. No. 6,541,591 discloses incorporation of 4,4′-bis(methacroyl thio)diphenyl sulfide monomer into a polymerizable composition to obtain a polymerizable composition with a high refractive index. However, such monomer is unduly expensive.

Given the above, it is desirable in the industry to provide a high refractive index polymer coating which does not have the above-mentioned disadvantages and is more economical, so as to improve the efficiency of the brightness enhancement film.

### SUMMARY OF THE INVENTION

The main purpose of the present invention is to provide a polymerizable composition having a high refractive index. Another purpose of the present invention is to provide an optical film comprising a substrate and at least one coating layer formed from the above polymerizable composition. The optical film can be used in backlight modules of displays as a brightness enhancement film.

With reference to the accompanying drawings and the following detailed description, person having ordinary skill in the art can easily understand the spirit of the present invention and the technical means and preferred embodiments according to the present invention.

### BRIEF DESCRIPTION OF THE DRAWINGS

FIG. 1 is a schematic view of an optical film according to one embodiment of the present invention.

### DETAILED DESCRIPTION OF THE INVENTION

It should be noted that the terminology used in the description is for the purpose of describing the embodiments only and not intended to limit the protection scope of the present invention. For example, as used herein, the terms “a,” “an,” and “the” include singular and plural references unless the context clearly dictates otherwise.

The present invention provides a polymerizable composition with a high refractive index of at least 1.53 and comprising:

(a) at least one monomer of formula (I):

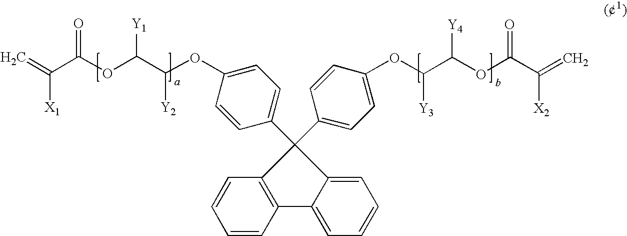

wherein X₁ and X₂ are each independently H or C₁-C₄alkyl, preferably H or methyl; Y₁, Y₂, Y₃ and Y₄ are each independently H, C₁-C₄alkyl or OH, preferably H or methyl; and a and b are each independently an integer from 0 to 5, preferably an integer from 1 to 3; and

(b) a photo-initiator.

The above monomer of formula (I) is a fluorene derivative diacrylate monomer, which has a high refractive index ranging from 1.61 to 1.65 so that it can effectively enhance the refractive index of the coating layer formed by curing the polymerizable composition. The amount of the monomer of formula (I), based on the total weight of the polymerizable composition, is at least 1 wt %, preferably from 1 to 50 wt %, more preferably from 3 to 25 wt %, and even more preferably from 4 to 20 wt %. In general, the refractive index cannot be effectively enhanced when the the monomer of formula (I) is used in an amount less than 1 wt %, and the resultant polymerizable composition will be too rigid to be coated when the monomer of formula (I) is used in an amount greater than 50 wt %.

Preferably, X₁, X₂, Y₁, Y₂, Y₃ and Y₄ in formula (I) are each independently H or methyl, and a and b are each independently an integer from 1 to 3. According to an embodiment of the present invention, the monomer of formula (I) is a monomer of formula (I₁):

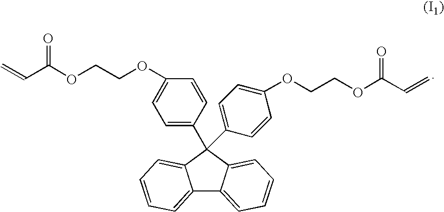

The photo initiator (component (b)) suitable for the polymerizable composition of the present invention is a compound that generates free radicals after being irradiated and initiates a polymerization through delivering the free radicals. The photo initiator of the present invention, for example, can be selected from benzophenone, benzoin, benzil, 2,2-dimethoxy-1,2-diphenylethan-1-one, 1-hydroxy cyclohexyl phenyl ketone, 2,4,6-trimethylbenzoyl diphenyl phosphine oxide (TPO) and a combination thereof, of which benzophenone is preferred.

The amount of the photo initiator of the present invention is not particularly limited and can be adjusted as needed, depending on the species and amount of the polymerizable monomers contained in the polymerizable composition. In general, the amount of the photo initiator, based on the total weight of the polymerizable composition, is ranging from 0.1 to 10 wt %, preferably from 0.1 to 5 wt %.

In order to increase the crosslinking degrees between the molecules, make it easy to cure the composition and enhance the hardness of the cured coating layer, some monomers or oligomers are normally added to a polymerizable composition as crosslinking agent. The polymerizable composition of the present invention optionally comprises a crosslinking agent (component (c)) to enhance the film-forming property of the polymerizable composition. The species of the crosslinking agent are well known to persons having ordinary skill in the art, which include for example, but are not limited to acrylates. The acrylates suitable for the present invention include, for example, but are not limited to (meth)acrylates; urethane acrylates, such as aliphatic urethane acrylate, aliphatic urethane hexaacrylate, or aromatic urethane hexaacrylate; polyester acrylates, such as polyester diacrylate; epoxy acrylates, such as bisphenol-A epoxy diacrylate; and novolac epoxy acrylates; and a mixture thereof. The above-mentioned (meth)acrylates can have two or more functional groups, of which the (meth)acrylates that have more than two functional groups are preferred. The (meth)acrylates suitable for the present invention include, for example, but are not limited to tripropylene glycol di(meth)acrylate, 1,4-butanediol di(meth)acrylate, 1,6-hexanediol di(meth)acrylate, polyethyleneglycol di(meth)acrylate, allylated cyclohexyl di(meth)acrylate, isocyanurate di(meth)acrylate, ethoxylated trimethylol propane tri(meth)acrylate, propoxylated glycerol tri(meth)acrylate, trimethylol propane tri(meth)acrylate, and tris(acryloxyethyl) isocyanurate, and a mixture thereof.

The commercially available acrylates suitable for the present invention as component (c) include, for example, but are not limited to the acrylates under the trade names SR454®, SR494®, SR9020®, SR9021®, and SR9041® produced by Sartomer company; the acrylate under the trade name 624-100® produced by Eternal company; and the acrylates under the trade names Ebecryl 600®, Ebecryl 830®, Ebecryl 3605®, and Ebecryl 6700® produced by UCB company.

If used, the amount of component (c), based on the total weight of the polymerizable composition, is ranging from 1 to 60 wt %, preferably from 10 to 50 wt %, more preferably from 25 to 40 wt %.

The viscosity of a polymerizable composition will vary with the species and amounts of the components contained in the composition, the operation temperature, and so on. When the viscosity of a composition is overly high, its operability becomes worse and the composition is not suitable for being coated and the disadvantages, such as poor leveling property, may occur. According to the present invention, an acrylate monomer of formula (II) (component (d)) can be optionally added to the polymerizable composition to dilute the composition and adjust the viscosity thereof. The structure of the monomer of formula (II) is as follows:

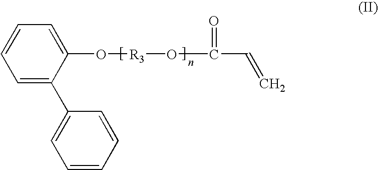

wherein R₃ is straight or branched chain hydrocarbon having 2 to 6 carbon atoms, which is optionally interrupted by one or more heteroatoms selected from oxygen and sulfur; and n is an integer from 0 to 3.

If used, the amount of component (d), based on the total weight of the polymerizable composition, is ranging from 1 to 80 wt %, preferably from 8 to 70 wt %, more preferably from 12 to 60 wt %.

Preferably, the monomer of formula (II) is a monomer of formula (II₁):

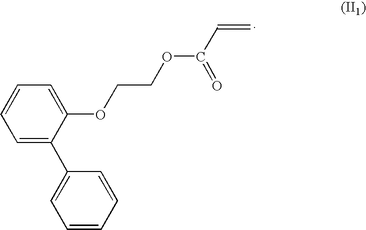

It is found that adding an acrylate monomer of formula (II) to the polymerizable composition of the present invention can adjust the viscosity of the composition so that it is suitable for being coated and the resultant composition still has a high refractive index after being cured.

Other suitable acrylate monomers (component (d-1)) can be optionally used for dilution. The acrylate monomers (component (d-1)) suitable for the present invention include, for example, but are not limited to acrylates, methacrylates, 2-phenoxyl ethyl acrylate, trimethylolpropane triacrylate, cumyl phenoxyl ethyl acrylate, propoxylated neopentyl glycol diacrylate, ethoxylated trimethylolpropane triacrylate, propoxylated trimethyloipropane triacrylate, and dipentaerythritol hexaacrylate (DPHA), and a mixture thereof. The commercially available acrylate monomers include the monomers under the trade names EM2108®, EM210® and EM231® produced by Eternal company.

If used, the amount of component (d-1), based on the total weight of the polymerizable composition, is ranging from 1 to 80 wt %, preferably from 8 to 70 wt %, more preferably from 12 to 60 wt %.

In order to avoid an overly high viscosity resulting from an excessive molecular weight of the polymerizable composition, both components (d) and (d-1) can optionally be used for dilution.

In order to increase the refractive index and the luminance of the optical film, the composition of the present invention optionally comprises a high refractive index monomer of formula (III) (component (e)):

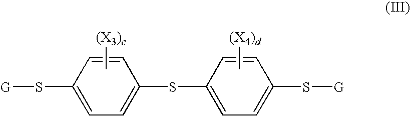

wherein X₃ and X₄ are each independently H, C₁-C₄alkyl or halogen, preferably H, methyl or halogen; c and d are each independently an integer from 1 to 4; and G is selected from the group consisting of:

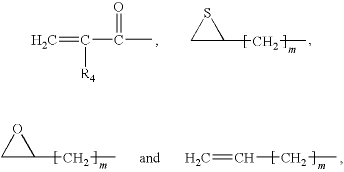

wherein R₄ is H or C₁-C₄alkyl, preferably H or methyl; and m is an integer from 0 to 6.

Preferably, the monomer of formula (III) is a monomer of formula (III₁):

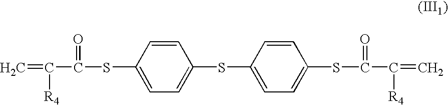

wherein R₄ is as defined hereinbefore.

More preferably, the monomer of formula (III) is a monomer of formula (III₂):

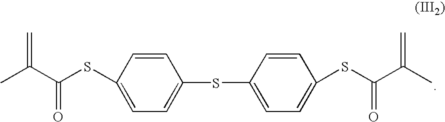

If used, the amount of the monomer of formula (III), based on the total weight of the polymerizable composition, is ranging from 1 to 60 wt %, preferably from 15 to 30 wt %.

In addition, the composition of the present invention may optionally contain any conventional additives to adjust the physical or chemical properties thereof. In general, the additives suitable for the present invention can be selected from inorganic fillers, an anti-static agent, a slip agent, a leveling agent, a defoamer and a combination thereof.

In order to enhance the hardness of the coating layer formed by curing the composition, the composition optionally comprises inorganic fillers to avoid the collapse of light-gathering structures that will adversely affect the optical properties. Inorganic fillers further enhance the brightness of LCD panels. The inorganic fillers suitable for the present invention can be any inorganic fillers known to persons having ordinary skill in the art, which can be, for example, but are not limit to zinc oxide, silicon dioxide, strontium titanate, zirconia, alumina, calcium carbonate, titanium dioxide, calcium sulphate, barium sulfate, or a mixture thereof, of which titanium dioxide, zirconia, silicon dioxide, zinc oxide, or a mixture thereof is preferred. The above-mentioned inorganic fillers have a particle size from about 10 nm to about 350 nm, preferably from 50 nm to 150 nm.

An anti-static agent may optionally added to the polymerizable composition of the present invention to impart the composition with anti-static properties and to further improve the yield of the manufacture process. The anti-static agent suitable for the present invention can be any anti-static agent well known to persons having ordinary skill in the art, which can be for example, but is not limited to ethoxy glycerin fatty acid esters, quaternary amine compounds, aliphatic amine derivatives, epoxy resins (such as polyethylene oxide), siloxane, or other alcohol derivatives, such as poly(ethylene glycol) ester, poly(ethylene glycol) ether and the like.

According to a preferred embodiment of the present invention, an oligomer is added to the polymerizable composition of the present invention as a crosslinking agent to increase the crosslinking degree between molecules and enhance the hardness of the coating layer formed after the polymerizable composition is cured. The resultant coating layer has a pendulum hardness of 50 or more, preferably ranging from 50 to 70. In general, the wear resistance of the coating layer is worse when the pendulum hardness is less than 50 and the coating layer is brittle when the pendulum hardness is more than 70. The species of the crosslinking agent are as those described above.

The polymerizable composition of the present invention can be coated on a substrate or an optical thin sheet, such as any conventional diffusive film or light-gathering film, to form a coating layer, thereby enhancing the wear resistance of the surface and providing excellent smoothness. Furthermore, since the polymerizable composition of the present invention contains a high refractive index monomer of formula (I), the formed coating layer has a high refractive index. The refractive index of the coating layer of the present invention is at least 1.53, preferably ranging from 1.53 to 1.62, so that the luminance of the optical film can be effectively enhanced.

The above-mentioned substrate can be any substrate known to persons having ordinary skill in the art, such as a glass or plastic substrate. The plastic substrate can be composed of one or more polymeric resin layers. The species of the resins used to form the polymeric resin layers are not particularly limited, and can be, for example, selected from polyester resins, such as polyethylene terephthalate (PET) and polyethylene naphthalate (PEN); polyacrylate resins, such as polymethyl methacrylate (PMMA); polyolefin resins, such as poly(ethlyene) (PE) and poly(propylene) (PP); polycycloolefin resins; polyimide resins; polycarbonate resins; polyurethane resins; triacetate cellulose (TAC); polylactic acid (PLA); and a combination thereof. The resin is preferably selected from polyester resins, polycarbonate resins and a combination thereof. More preferably, the resin is polyethylene terephthalate. The thickness of the substrate is generally from 30 μm to 300 μm, usually depending on the desired purpose of an optical product.

According to a preferred embodiment of the present invention, the substrate used in the present invention comprises a single layer or multiple layers of convex-concave microstructures. The single layer or multiple layers of convex-concave microstructures imparts the optical film with the desired optical properties. Their types are not particularly limited and can be any of those known to persons having ordinary skill in the art, such as diffusive structures for diffusing light and/or light-gathering structures for gathering light. The above single or multiple layer structures and the substrate of the present invention can be formed integrally by, for example, an embossing process, injection or biaxial stretching. Alternatively, the above single or multiple layer structures can be formed by processing the substrate with any conventional methods. For example, the substrate can be coated with a coating containing particles so that a convex-concave microstructure layer is directly formed thereon, or a coating is applied onto the substrate and the resultant coating layer is carved to form the desired convex-concave microstructures.

The present invention further provides an optical film comprising a coating layer formed from the polymerizable composition of the present invention. The coating layer can be flat or have specific microstructures, such as diffusive microstructures or light-gathering microstructures.

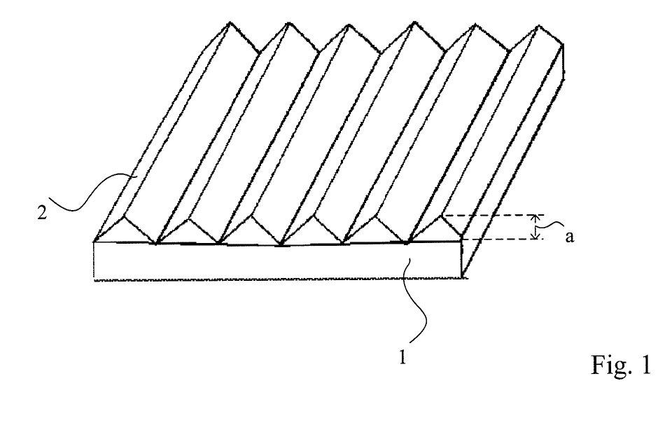

FIG. 1 is a schematic view of an optical film according to one embodiment of the present invention. As shown in FIG. 1, the optical film of the present invention comprises a substrate 1 and a coating layer 2 having light-gathering structures.

The thickness of the coating layer of the optical film according to the present invention is generally ranging from 1 μm to 100 μm, preferably from 10 μm to 40 μm. When the coating layer has specific microstructures, the thickness of the coating layer is measured from the highest point of the microstructures. For example, for the optical film of FIG. 1, the thickness of the coating layer 2 is represented by symbol “a.”

According to one embodiment of the present invention, the coating layer has light-gathering structures. The light-gathering structures of the optical film of the present invention are known to persons having ordinary skill in the art, which can be, for example, but are not limited to regularly or irregularly arranged, prism columnar structures (i.e., triangular columns), arc columnar structures (i.e., the columnar structures having round tops), conical columnar structures, solid angle structures, orange-segment like structures, lens-like structures, or capsule-like structures, or a combination thereof, of which prism columnar structures and arc columnar structures are preferred. Moreover, the prism columnar structures and/or arc columnar structures can be linear, zigzag, or serpentine, and two adjacent columnar structures can be parallel or non-parallel.

The optical film of the present invention can be fabricated by any conventional method which is known to persons having ordinary skill in the art. For example, it may be produced by the method comprising the following steps:
(1) mixing a monomer of formula (I), a photo-initiator, an optional monomer of formula (II), a crosslinking agent and other additives to form a colloidal polymerizable composition;
(2) applying the colloidal polymerizable composition obtained from step (1) onto a substrate by any suitable method so as to form a coating layer thereon, and then performing, for example, a roller embossing method, so as to form prism structures; and
(3) curing the coating layer, for example, by irradiating the coating layer with energy light rays at ambient or an elevated temperature.

If needed, the above steps can be repeated so as to produce an optical film comprising a plurality of coating layers.

To avoid being scratched and adversely affecting the optical properties, a scratch-resistant layer can be optionally formed on the surface opposite to the surface on which the coating layer from the polymerizable composition of the present invention was formed. The scratch-resistant layer can be smooth or non-smooth. The thickness of the scratch-resistant layer is preferably in the range from 0.5 to 30 μm, and the scratch-resistant layer has a haze in the range from 1% to 90%, preferably from 5% to 40%, as measured according to JIS K7136 standard method. The optical film of the present invention has a total transmittance no less than 60%, preferably more than 80%, and more preferably 90% or more, as measured according to JIS K7136 standard method.

The optical film made from the polymerizable composition of the present invention has a high refractive index of at least 1.53, can provide good brightness enhancement. Moreover, since the coating layer does not contain halogen, it will not pollute the environment. Therefore, the present invention can effectively solve the problem in the art. In addition, the polymerizable composition of the present invention has good leveling property and is economically competitive due to lower cost.

The following examples are used to further illustrate the present invention.

### EXAMPLES 1-11

The optical films of Examples 1 to 11 were prepared by the process described below and the compositions used in the examples were listed in Table 1.

Firstly, the components were mixed according to the proportions given in Table 1 and stirred at 50° C. and at a rate of 1,000 rpm, and then colloidal polymerizable compositions were formed.

The colloidal polymerizable compositions were respectively applied onto a polyethylene terephthalate (PET) substrate [U34®, Toray Company] to form a coating layer, and a roller embossing method was conducted to form prism structures on the coating layer. Then, energy light rays were used at ambient temperature to irradiate the coating layer and cure the coating layer. Optical films with a coating layer having a thickness of 25 μm were obtained.

TABLE 1

| | Component | | | | |
|---|---|---|---|---|---|
| | (a) | (b) | (c) | (d) | (d-1) |
| Example | (g) | (g) | (g) | (g) | (g) |
| 1 | 2.5 | 3 | 30 | 7.5 | 0 |
| 2 | 5.0 | 3 | 30 | 15.0 | 0 |
| 3 | 7.5 | 3 | 30 | 22.5 | 0 |
| 4 | 10.0 | 3 | 30 | 30.0 | 0 |
| 5 | 12.5 | 3 | 30 | 37.5 | 0 |
| 6 | 15.0 | 3 | 30 | 45.0 | 0 |
| 7 | 10.0 | 3 | 30 | 0 | 0 |
| 8 | 10.0 | 3 | 30 | 0 | 30 |
| 9 (comparative) | 0 | 3 | 30 | 0 | 0 |
| 10 (comparative) | 0 | 3 | 30 | 0 | 50 |
| 11 (comparative) | 0 | 3 | 30 | 30 | 0 |

(a): monomer of formula (I) (A-BPEF, Shin-Nakamura company)
(b): photo-initiator (I184 ®, Ciba company)
(c): crosslinking agent (624-100 ®, Eternal company)
(d): monomer of formula (II) (A-LEN10, Shin-Nakamura company)
(d-1): acrylate monomer (EM210 ®, Eternal company)

The optical films of the above examples were subjected to refractive index test (using AUTOMATIC REFRACTOMETER GPR11-37® instrument provided by Index Instruments), and applied to a 22″ edge-type backlight module for luminance gain test (using BM-7® instrument provided by Topcon Company). The results were reported in Table 2.

TABLE 2

| Example | refractive index | luminance gain |
|---|---|---|
| 1 | 1.5312 | 65.8% |
| 2 | 1.5375 | 67.32% |
| 3 | 1.5449 | 69.14% |
| 4 | 1.5542 | 71.01% |
| 5 | 1.5580 | 71.68% |
| 6 | 1.5641 | 72.57% |
| 7 | 1.5539 | 70.96% |
| 8 | 1.5536 | 70.05% |
| 9 (comparative) | 1.5135 | 59.2% |
| 9 (comparative) | 1.5252 | 62.81% |
| 9 (comparative) | 1.533 | 66.83% |

It can be seen from the results of Examples 1 to 8 in Table 2 that the refractive indexes of all of the coating layers formed from the polymerizable compositions of the present invention are higher than 1.53. Furthermore, when the film is applied to a backlight module, the resulting luminance and light gathering effect vary positively and correspondingly with the refractive index of the coating layer—the higher the refractive index, the greater the achieved luminance and light-gathering effect.

It can be seen from Tables 1 and 2 that the compositions of comparative examples 9 and 10 do not contain a monomer of formula (I) and cannot effectively enhance the refractive index.

It can be seen from Table 1 that a monomer of formula (II) for dilution was added to the composition of comparative example 11 to improve the leveling property. It can be seen from the results in Table 2 that as compared to the compositions of comparative examples 9 and 10, the refractive index of the composition of comparative example 11 is slightly increased due to the addition of the monomer of formula (II). However, It can be seen from the results of comparative example 11 and example 4 in Table 2 that in addition to adding a monomer of formula (II) for improving the leveling property, the composition of example 4 further comprises a monomer of formula (I) and has a higher refractive index as compared to the composition of comparative example 11.

It can be seen from the results of examples 4, 7 and 8 in Tables 1 and 2 that with the addition of the monomer of formula (I), these compositions have similar enhancement in the refractive index, no matter whether monomer of formula (II) or (d-1) is added or not. As measured by a viscosity meter, the viscosities of the compositions of examples 4, 7 and 8 are 130 cps, 180 cps and 100 cps, respectively. Hence, it can be seen that the addition of a monomer of formula (II) or a monomer of formula (d-1) can improve the leveling property of a composition without affecting the increase in refractive index caused by a monomer of formula (I).

The above examples are provided to illustrate the embodiments of the present invention and the technical features of the embodiments, but not intended to limit the scope of the present invention. Any modifications or alterations that can easily be accomplished by persons having ordinary skill in the art fall within the scope of the present invention. The scope of the present invention is described in the appended claims.

1. A polymerizable composition, comprising:
(a) at least one monomer of formula (I): 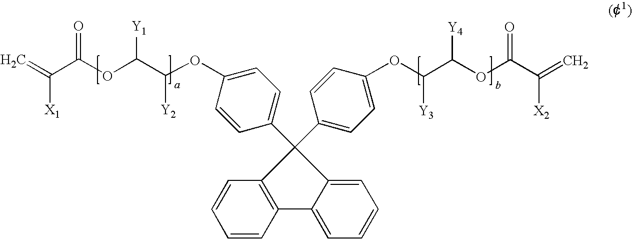
wherein X₁ and X₂ are each independently H or C₁-C₄alkyl; Y₁, Y₂, Y₃ and Y₄ are each independently H, C₁-C₄alkyl or OH; and a and b are each independently an integer from 0 to 5; and
(b) a photo-initiator.

2. The composition as claimed in claim 1, wherein X₁, X₂ Y₁, Y₂, Y₃ and Y₄ are each independently H or methyl; and a and b are each independently an integer from 1 to 3.

3. The composition as claimed in claim 1, wherein the monomer of formula (I) has formula (I₁):

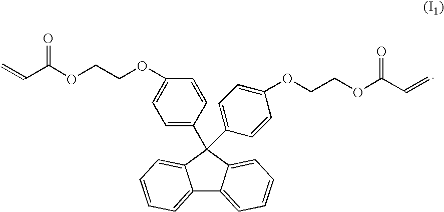

4. The composition as claimed in claim 1, wherein the monomer of formula (I) is present in an amount ranging from 1 wt % to 50 wt %, based on the total weight of the polymerizable composition.

5. The composition as claimed in claim 1, wherein the monomer of formula (I) is present in an amount ranging from 3 wt % to 25 wt %, based on the total weight of the polymerizable composition.

6. The composition as claimed in claim 1, wherein the monomer of formula (I) is present in an amount ranging from 4 wt % to 20 wt %, based on the total weight of the polymerizable composition.

7. The composition as claimed in claim 1, wherein the photo initiator is selected from the group consisting of benzophenone, benzoin, benzil, 2,2-dimethoxy-1,2-diphenylethan-1-one, 1-hydroxy cyclohexyl phenyl ketone, 2,4,6-trimethylbenzoyl diphenyl phosphine oxide and a combination thereof.

8. The composition as claimed in claim 1, wherein the photo initiator is present in an amount ranging from 0.1 wt % to 10 wt %, based on the total weight of the polymerizable composition.

9. The composition as claimed in claim 1, further comprising (d) an acrylate monomer of formula (II): 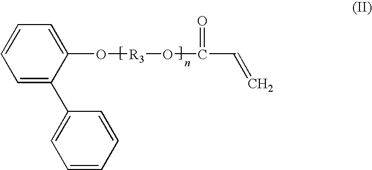
wherein R₃ is a straight or branched chain hydrocarbon having 2 to 6 carbon atoms, which is optionally interrupted by one or more heteroatoms selected from oxygen and sulfur; and n is an integer from 0 to 3.

10. The composition as claimed in claim 9, wherein the monomer of formula (II) is present in an amount ranging from 1 wt % to 80 wt %, based on the total weight of the polymerizable composition.

11. The composition as claimed in claim 9, wherein the monomer of formula (II) is present in an amount ranging from 8 wt % to 70 wt %, based on the total weight of the polymerizable composition.

12. The composition as claimed in claim 9, wherein the monomer of formula (II) is present in an amount ranging from 12 wt % to 60 wt %, based on the total weight of the polymerizable composition.

13. The composition as claimed in claim 1, further comprising (d-1) an acrylate monomer selected from the group consisting of acrylates, methacrylates, 2-phenoxyl ethyl acrylate, trimethylolpropane triacrylate, cumyl phenoxyl ethyl acrylate, propoxylated neopentyl glycol diacrylate, ethoxylated trimethylolpropane triacrylate, propoxylaed trimethyloipropane triacrylate, dipentaerythritol hexaacrylate, and a mixture thereof.

14. The composition as claimed in claim 13, wherein the acrylate monomer is present in an amount ranging from 1 wt % to 80 wt %, based on the total weight of the polymerizable composition.

15. The composition as claimed in claim 1, further comprising (c) a crosslinking agent.

16. The composition as claimed in claim 15, wherein the crosslinking agent is a (meth)acrylate, a urethane acrylate, a polyester acrylate, an epoxy acrylate, or a combination thereof.

17. The composition as claimed in claim 15, wherein the crosslinking agent is present in an amount ranging from 1 wt % to 60 wt %, based on the total weight of the polymerizable composition.

18. The composition as claimed in claim 15, wherein the crosslinking agent is present in an amount ranging from 10 wt % to 50 wt %, based on the total weight of the polymerizable composition.

19. The composition as claimed in claim 15, wherein the crosslinking agent is present in an amount ranging from 25 to 40 wt %, based on the total weight of the polymerizable composition.

20. The composition as claimed in claim 1, further comprising an additive selected from the group consisting of a slip agent, inorganic fillers, a leveling agent, a defoamer, an anti-static agent and a combination thereof.

21. The composition as claimed in claim 18, wherein the inorganic fillers are selected from the group consisting of titanium dioxide, silicon dioxide, strontium titanate, zinc oxide, alumina, barium sulfate, calcium sulphate, calcium carbonate, zirconia and a combination thereof.

22. The composition as claimed in claim 18, wherein the inorganic fillers have a particle size of 10 nm to 350 nm.

23. A polymerizable composition, comprising:
(a) at least one monomer of formula (I): 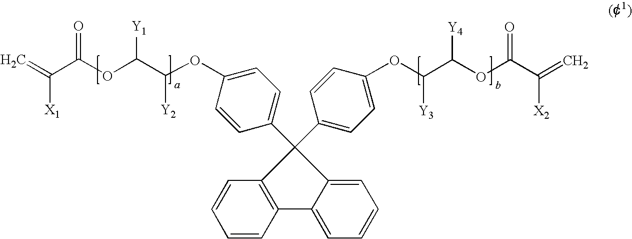
wherein X₁ and X₂ are each independently H or methyl; Y₁, Y₂, Y₃ and Y₄ are each independently H or methyl; and a and b are each independently an integer from 1 to 3;
(b) a photo-initiator selected from the group consisting of benzophenone, benzoin, benzil, 2,2-dimethoxy-1,2-diphenylethan-1-one, 1-hydroxy cyclohexyl phenyl ketone, 2,4,6-trimethylbenzoyl diphenyl phosphine oxide and a combination thereof; and
(c) a crosslinking agent selected from the group consisting of acrylates, methacrylates, urethane acrylates, polyester acrylates, epoxy acrylates and a combination thereof,
wherein the amount of the monomer of formula (I), based on the total weight of the polymerizable composition, is at least 1 wt %.

24. The composition as claimed in claim 23, wherein the monomer of formula (I) has formula (I₁):

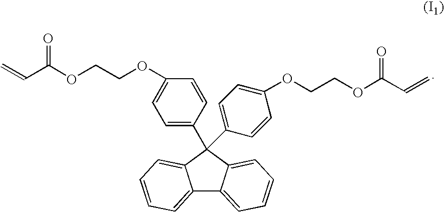

25. The composition as claimed in claim 23, further comprising (d) a monomer of formula (II₁):

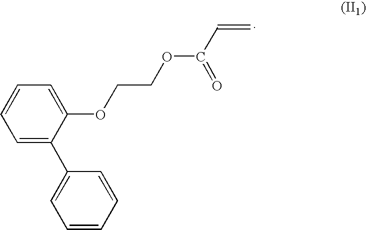

26. An optical film, comprising a coating layer formed from the polymerizable composition as claimed in claim 1.

27. The optical film as claimed in claim 26, wherein the coating layer has light-gathering structures.

28. The optical film as claimed in claim 26, wherein the coating layer has a refractive index of more than 1.53.

29. The optical film as claimed in claim 26, wherein the coating layer has a refractive index ranging from 1.53 to 1.62.

30. The optical film as claimed in claim 26, wherein the coating layer has a thickness from 1 μm to 100 μm.

31. An optical film, comprising a coating layer formed from the polymerizable composition as claimed claim 23.
